(19) United States
(12) Patent Application Publication
(10) Pub. No.: US 2013/0091363 A1
(43) Pub. Date: Apr. 11, 2013

(54) POWER SUPPLY SYSTEM FOR CENTRAL PROCESSING UNIT

(71) Applicants: YING-BIN FU, Shenzhen City (CN); TING GE, Shenzhen City (CN); YA-JUN PAN, Shenzhen City (CN)

(72) Inventors: YING-BIN FU, Shenzhen City (CN); TING GE, Shenzhen City (CN); YA-JUN PAN, Shenzhen City (CN)

(73) Assignees: HON HAI PRECISION INDUSTRY CO., LTD., Tu-Cheng (TW); HON FU JIN PRECISION INDUSTRY(ShenZhen) CO., LTD., Shenzhen City (CN)

(21) Appl. No.: 13/314,293

(22) Filed: Dec. 8, 2011

(30) Foreign Application Priority Data
Oct. 10, 2011 (CN) 201110304383.8

(51) Int. Cl. G06F 1/26

(52) U.S. Cl. 713/300

(57) ABSTRACT

A power supply system for a central processing unit (CPU) mounted on a motherboard includes a power supply unit, a conducting layer, and a number of conducting foils. The conducting layer is set on the motherboard. The conducting foils are connected to the conducting layer in parallel. The power supply unit supplies power to the CPU through the conducting layer and the conducting foils.

### BACKGROUND

1. Technical Field

The present disclosure generally relates to power supply systems, and specifically for a power supply system for a central processing unit (CPU).

2. Description of Related Art

A power supply unit supplies power to a CPU through a conducting layer set on a motherboard. When the CPU operates at a high performance state, the current flowing through the conducting layer is high. Reducing the size of the conducting layer to reduce the resistance and thereby reducing the power may result in the conduction layer being damage or destroyed. Therefore there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic view of an exemplary embodiment of a power supply system for a central processing unit (CPU), wherein the power supply system includes a conducting layer and conducting foils.

FIGS. 2 and 3 are schematic views of the conducting layer and the conducting foils.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

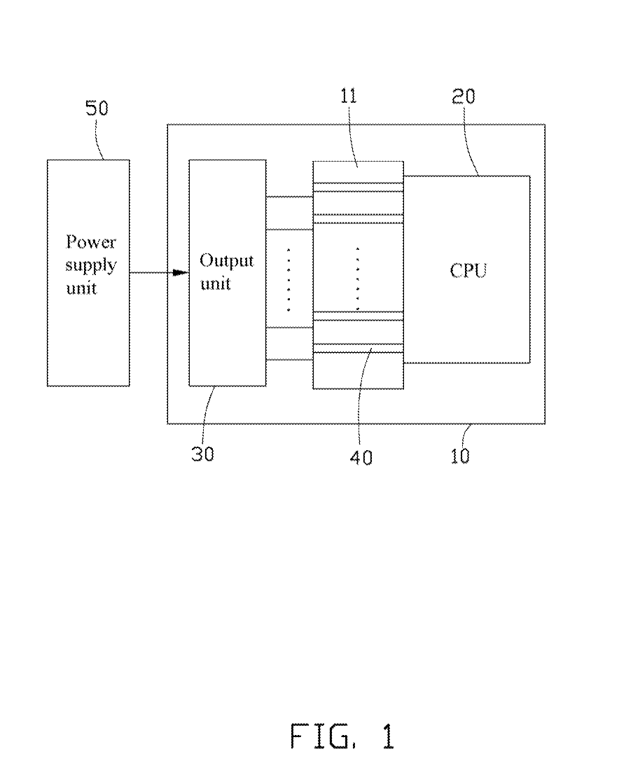

Referring to FIG. 1, an exemplary embodiment of a power supply system for a central processing unit (CPU) 20 includes a motherboard 10, an output unit 30, and a power supply unit 50. The CPU 20 and the output unit 30 are mounted on the motherboard 10.

The power supply unit 50 is connected to the output unit 30. The output unit 30 is connected to the CPU 20 through a conducting layer 11 mounted on the motherboard 10. The power supply unit 50 supplies power to the CPU 20 through the output unit 30 and the conducting layer 11. In this embodiment, the conducing layer 11 is made of copper.

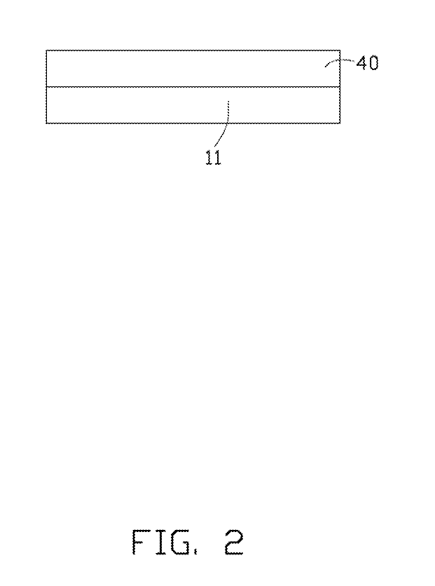

Referring to FIG. 2, a plurality of conducting foils 40 are mounted on the conducting layer 11. The conducting foils 40 are connected to the conducting layer 11 in parallel. In this embodiment, the conducting foils 40 are made of copper.

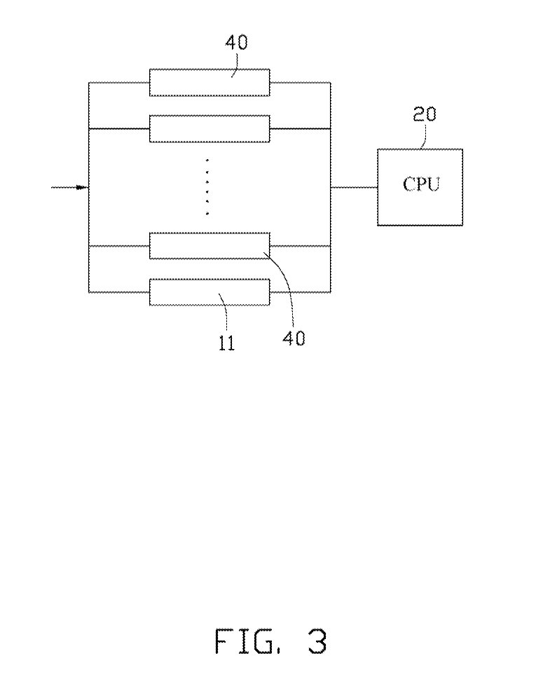

Referring to FIG. 3, when the CPU 20 operates at a high performance state, a current flowing through the conducting layer 11 would be hundreds of amperes. According to the formula P=I*I*R, wherein P stands for the power, I stands for the current, and R stands for the resistance. Thus if the resistance can be reduced the power will be reduced.

A resistance of the conducting layer 11 is defined as R1. A resistance of each conducting foil 40 is defined as R2. In this embodiment, there is just a conducting foil 40. As a result, after the conducting layer 11 is connected to the conducting foil 40 in parallel, an equivalent resistance is

$$\frac{R 1 * R 2}{R 1 + R 2} .$$

### Obviously,

$$\frac{R 1 * R 2}{R 1 + R 2}$$

is less than R1. As a result, the power P is reduced. Obviously, in other embodiments, when there are a plurality of conducting foils 40, the equivalent resistance is also less than R1.

The foregoing description of the exemplary embodiments of the disclosure has been presented only for the purposes of illustration and description and is not intended to be exhaustive or to limit the disclosure to the precise forms disclosed. Many modifications and variations are possible in light of everything above. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A power supply system for a central processing unit (CPU) mounted on a motherboard, the power supply system comprising:
a power supply unit;
a conducting layer set on the motherboard, wherein the conducting layer is connected between the CPU and the power supply unit; and
a plurality of conducting foils connected to the conducting layer in parallel, wherein the power supply unit supplies power to the CPU through the conducting layer and the conducting foils.

2. The power supply system of claim 1, wherein the conducting layer is made of copper.

3. The power supply system of claim 1, wherein the conducting foils are made of copper.

4. The power supply system of claim 1, further comprising an output unit connected between the power supply unit and the conducting layer.
